(19) United States
(12) Patent Application Publication
(10) Pub. No.: US 2008/0251976 A1
(43) Pub. Date: Oct. 16, 2008

(54) Micro and nano-spacers having highly uniform size and shape

(75) Inventors: Jason P. Rolland, Durham, NC (US); Ginger D. Rothrock, Durham, NC (US)

Correspondence Address: MORGAN, LEWIS & BOCKIUS LLP, 1701 MARKET STREET, PHILADELPHIA, PA, 19103-2921, US

(73) Assignee: Liquidia Technologies, Inc.

(21) Appl. No.: 11/787,057

(22) Filed: Apr. 13, 2007

(51) Int. Cl. B32B 1/00; B28B 1/00; C09K 19/00; B28B 5/00

(52) U.S. Cl. 264/605; 264/241; 428/1.5; 428/220; 428/80

(57) ABSTRACT

A spacer for forming a gap in a device includes a predetermined geometric shape and is less than about 500 micrometers in a broadest dimension. A plurality of spacers can be fabricated where each spacer of the plurality of spacers has a predetermined geometric shape, the same predetermined geometric shape, or a variety of predetermined geometric shapes. The spacers of the plurality of spacers can also include a polydispersity of about 1.0005. The spacer can be positioned between two components of a device to provide accurate spacing of the components.

### TECHNICAL FIELD OF THE INVENTION

Generally, the present invention relates to micro and nano-spacers for maintaining a micro or nano sized gap between components of a device. More particularly, the micro or nano-spacers are fabricated in a predetermined shape with uniform size and organization.

### BACKGROUND OF THE INVENTION

Current manufacturing processes and manufactured devices often require precise and fine spacing between components. For example, a liquid crystal display (LCD) device includes spacers for maintaining a gap between two glass substrates at a constant distance. Presently, the spacer used in an LCD is a fine particle having a diameter of about several micrometers. The spacers are available in many compositions, having well defined hardness and elastic modulus, are typically spherical or column shaped, and can be delivered to the glass substrate through incorporation in a liquid, spin coated, or deposited via ink-jetting.

These common spacers and the methods of application have many drawbacks. One drawback is that during application of the spacers, these spacers become spread on a substrate in random fashion. Often the spacers are presented to a desired location by being dispersed in a liquid or adhesive composition and spread or spin coated. With such procedures, the spacers often become located in positions that are less than ideal and/or interfere with the operation of the device. For example, in a display device, spacers may become located within a pixel portion which could result in problems such as light leaking due to the irregular alignment of liquid crystal around the spacer and the contrast of an image may be deteriorated. Therefore, there is a need for spacers and methods of making and applying the spacers that result in precise predetermined placement of the spacers.

Another drawback is the variance in size and/or shape between individual spacer particles. Current spacer manufacturing techniques are inadequate for fabricating particle spacers of a variety of shapes and of a variety of materials while maintaining very limited variation in size and/or shape between individual spacers. Currently, fine particle spacers described to have a specific size actually include spacers having a range of sizes with a coefficient of variation among the particles between about 5 and 10 percent. Often spacers with such variation in size and/or shape are referred to as monodisperse, as described in Polysciences, Inc. Data Sheet #623 available at http://www.polysciences.com/shop/assets/datasheets/623.pdf, which is incorporated herein by reference. However, spacers with such variation in size and/or shape are not truly monodisperse and such variation effectively limits the functional capabilities of many devices such as the LCD devices discussed above.

Other drawbacks include limitations on the composition and geometric shape of the spacers due to complicated manufacturing procedures.

### SUMMARY OF THE INVENTION

According to some embodiments, a device having a gap between components includes a first component of a device and a second component of the device positioned with respect to the first component. The first and second components of the device are spaced apart by a spacer positioned between the first component and the second component where the spacer has a predetermined geometric shape and is less than about 500 micrometers in a broadest dimension. The device can include a plurality of spacers where each spacer of the plurality of spacers has a predetermined geometric shape. The plurality of spacers can include substantially the same predetermined geometric shape or a variety of predetermined geometric shapes. In alternate embodiments, the plurality of spacers includes polydispersity in broadest dimension of less than about 1.0010, less than about 1.0008, less than about 1.0006, or less than about 1.0005.

In some embodiments, the spacer is fabricated in a mold having the predetermined geometric shape of the spacer. In some embodiments, the mold includes a fluoropolymer or a perfluoropolyether precursor. In alternative embodiments, the spacer is less than about 400 micrometers in a broadest dimension, less than about 200 micrometers in a broadest dimension, less than about 100 micrometers in a broadest dimension, less than about 50 micrometers in a broadest dimension, less than about 10 micrometers in a broadest dimension, less than about 1 micrometer in a broadest dimension, about 0.5 micrometers and about 10 micrometers in a broadest dimension, between about 1 micrometer and about 7 micrometers in a broadest dimension, between about 1.5 micrometers and about 5 micrometers in a broadest dimension, between about 2 micrometers and about 4 micrometers in a broadest dimension, less than about 0.75 micrometers in a broadest dimension, less than about 0.5 micrometers in a broadest dimension, less than about 0.25 micrometers in a broadest dimension, less than about 0.10 micrometers in a broadest dimension, less than about 75 nanometers in a broadest dimension, less than about 50 nanometers in a broadest dimension, less than about 25 nanometers in a broadest dimension.

In other embodiments, the predetermined geometric shape of the spacer has two substantially flat and substantially parallel sides. In alternate embodiments, the predetermined geometric shape of the spacer includes a predetermined radius of curvature, a predetermined angle between two sides of the spacer, a cuboidal shape, a conical shape, a spherical shape, a cylindrical shape, a rectangular shape, a cube shape, a cone shape, a sphere shape, a cylinder shape, and a rectangle shape.

In yet other embodiments, the spacer includes a film coupled to each spacer of the plurality of spacers. In some embodiments, each spacer of the plurality of spacers is coupled with the film in a predetermined location. In other embodiments, each spacer of the plurality of spacers is coupled with the film in a predetermined random location. The predetermined random location can be mathematically selected and the mathematically selected predetermined random location reduces a probability of a spacer interfering with a device component.

In some embodiments, the spacer for forming a gap in a device includes a film layer and a spacer coupled with the film layer where the spacer includes a predetermined geometric shape less than about 500 micrometers in a broadest dimension. In some embodiments the predetermined geometric shape includes a predetermined radius of curvature. In other embodiments the predetermined geometric shape includes a substantially flat surface having a predetermined width, a substantially flat surface having a predetermined width, or two substantially flat surfaces, where the two substantially flat surfaces abut with a predetermined angle. In some embodiments, the spacer is integral with the film, positioned in a predetermined location with respect to the film, or each spacer of the plurality of spacers is coupled in a predetermined location on the film.

In some embodiments, the film includes a first composition and the spacer includes a second composition. In some embodiments, the film and the spacer include the same composition. In some embodiments, the film includes a predetermined thickness, the spacer is fabricated in a mold, the mold includes a fluoropolymer, or the mold includes a perfluoropolyether.

According to some embodiments, the spacer is positioned between a first component and a second component of an LCD, an automobile, an automobile manufacturing process, an electronic device, or an optical device.

According to methods of the present invention, a micro spacer method includes providing a mold defining a cavity having a predetermined geometric shape, where the cavity is less than about 500 micrometers in a broadest dimension, introducing a spacer precursor material into the cavity, forming a spacer from the spacer precursor material in the cavity, removing the spacer from the cavity, and applying the spacer to a first component of a device such that a gap is formed between the first component of the device and a second component of the device. In some embodiments, the method includes introducing spacer precursor material into each cavity of a plurality of cavities of the mold and forming spacers in each cavity of the plurality of cavities. The method also includes removing the spacers by applying a film to the spacers formed in the cavities such that the spacers adhere to the film and removing the film from the mold such that the spacers remain in contact with the film and are removed from the cavities.

According to other methods of the present invention, a method for positioning a spacer includes forming a spacer in a cavity of a mold, where the cavity includes a predetermined geometric shape and is less than about 500 micrometers in a broadest dimension, harvesting the spacer onto a film, and positioning the film with respect to a first device that is to be spaced from a second device.

### BRIEF DESCRIPTION OF THE FIGURES

FIGS. 1A-1D show a mold fabricated from a master template according to an embodiment of the present invention;

FIGS. 2A-2E show spacers fabricated from a mold according to an embodiment of the present invention;

FIGS. 3A-3F show spacers fabricated from a mold according to another embodiment of the present invention;

FIG. 4 shows a laminate mold according to an embodiment of the present invention;

FIG. 5 illustrates fabrication of a laminate mold according to an embodiment of the present invention;

FIGS. 6A-6E illustrate an embodiment of spacer fabrication according to the present invention;

FIGS. 7A-7E illustrate another embodiment of spacer fabrication according to the present invention;

FIGS. 8A-8F illustrate spacer fabrication and harvesting according to an embodiment of the present invention;

FIGS. 9A-9F show another embodiment of spacer fabrication and harvesting according to an embodiment of the present invention;

FIGS. 10A-10C show fabrication of spacers on a film according to an embodiment of the present invention;

FIGS. 11A-11C show fabrication of a spacer layer according to an embodiment of the present invention;

FIG. 12 shows an optical image of spacers fabricated and harvested according to embodiments of the present invention;

FIG. 13 shows another optical image of spacers fabricated and harvested according to embodiments of the present invention; and

FIG. 14 shows spacers forming a gap between a first component and a second component of a device according to an embodiment of the present invention.

### DETAILED DESCRIPTION OF EMBODIMENTS OF THE INVENTION

The present subject matter will now be described more fully hereinafter with reference to the accompanying Figures and Examples, in which representative embodiments are shown. The present subject matter can, however, be embodied in different forms and should not be construed as limited to the embodiments set forth herein. Rather, these embodiments are provided to describe and enable one of skill in the art. Unless otherwise defined, all technical and scientific terms used herein have the same meaning as commonly understood by one of ordinary skill in the art to which the subject matter belongs. All publications, patent applications, patents, and other references mentioned herein are incorporated by reference in their entirety. Furthermore, throughout the specification and claims a given chemical formula or name shall encompass all optical and stereoisomers, as well as racemic mixtures where such isomers and mixtures exist.

The present invention is broadly directed to micro and nano-spacers. The spacers are fabricated in cavities of patterned templates or molds formed of polymer material, such as a liquid fluoropolymer. The cavities are formed in the polymer molds by contacting the polymer, while in the liquid form, with a master template that includes micro or nano-sized features. The liquid polymer is then cured while in contact with the master, thereby forming a replica image of the structures on the master. After removal of the cured liquid polymer from the master template, the cured liquid polymer forms a mold that includes cavities or recess replicas of the micro or nano-sized features of the master template and the micro or nano-sized cavities in the cured liquid polymer can be used for high-resolution micro or nano-spacer fabrication. Such spacers can be useful in devices being selected from the group including, but not limited to a semiconductor device, a photovoltaic device, an additive, a sensor, an abrasive, a micro-electro-mechanical system (MEMS), an optical device, an electronic device, an automotive device, and the like.

I. Mold Materials

Representative materials useful in fabricating the molds from which spacers can be formed include elastomer-based materials. The elastomer-based materials include, but are not limited to, fluorinated elastomer-based materials, solvent resistant elastomer based materials, fluorinated elastomer-based materials that are liquid at room temperature, combinations thereof, and the like. As used herein, the term “solvent resistant” refers to a material, such as an elastomeric material that either does not swell or does not substantially swell nor dissolve or substantially dissolve in common hydrocarbon-based organic solvents, or reagents, or acidic or basic aqueous solutions. Representative fluorinated elastomer-based materials include but are not limited to fluoropolyether and perfluoropolyether (PFPE) based materials. For ease of discussion the remainder of this specification will primarily describe PFPE based materials, however, it should be appreciated that the articles and methods disclosed and enabled herein can be applied to or with other materials.

The materials for fabricating the molds having cavities (i.e., mold materials) from which the spacers are formed are typically liquid polymers at room temperature and can be made curable by addition of a thermal curable constituent, photo curable constituent, combination thereof, or the like. In one embodiment, the mold materials include dual cure materials. In some embodiments, the dual cure materials include a liquid material having dual cure ability can include a material having a photo-curable and a thermal-curable constituent, two or more photo-curable constituents that cure at different wavelengths, two or more thermal-curable constituents that cure at different temperatures, or the like. A material having the ability to undergo multiple cures is useful, for example, in forming articles of the present invention.

In some embodiments, photo-curable and thermal-curable constituents can undergo a first cure through, for example, a photocuring process or a thermal curing process such that an article is first cured. Then the first photocured or thermal cured article can be subjected to a second cure to activate the curable component not activated in the first cure. In some embodiments, a first cured article can be adhered to a second cured article of the same material or any material similar thereto that will thermally cure or photocure and bind to the material of the first cured article. By positioning the first cured article and second cured article adjacent one another and subjecting the first and second cured articles to a thermal curing or photocuring process, whichever component that was not activated on the first cure can be cured by a subsequent curing step. Thereafter, either the thermal cure constituents of the first cured article that were left un-activated by the photocuring process or the photocure constituents of the first cured article that were left un-activated by the first thermal curing, will be activated and bind the second article. Thereby, the first and second articles become adhered together upon a second curing. It will be appreciated by one of ordinary skill in the art that the order of curing processes is independent and a thermal-curing could occur first followed by a photocuring, a photocuring could occur first followed by a thermal curing, or the like.

According to yet another embodiment, multiple thermo-curable constituents can be included in the material such that the material can be subjected to multiple independent thermal-cures at different temperatures or different times of exposure. For example, the multiple thermo-curable constituents can have different activation temperature ranges such that the material can undergo a first thermal-cure at a first temperature range and a second thermal-cure at a second temperature.

According to one embodiment the PFPE material of the mold has a surface energy below about 30 mN/m. According to another embodiment the surface energy of the PFPE is between about 10 mN/m and about 20 mN/m. According to another embodiment, the PFPE has a low surface energy of between about 12 mN/m and about 15 mN/m. In some embodiments, the surface energy is less than about 12 mN/m.

The PFPE is non-toxic, UV transparent, and highly gas permeable; and cures into a tough, durable, highly fluorinated elastomer with excellent release properties and resistance to swelling. The properties of these materials can be tuned over a wide range through the judicious choice of additives, fillers, reactive co-monomers, and functionalization agents. Such properties that are desirable to modify, include, but are not limited to, modulus, tear strength, surface energy, permeability, functionality, mode of cure, solubility and swelling characteristics, and the like. The non-swelling nature and easy release properties of the presently disclosed PFPE materials allows for nanostructures to be fabricated from nearly any material. Further, the presently disclosed subject matter can be expanded to large scale rollers or conveyor belt technology or rapid stamping that allow for the fabrication of nanostructures on an industrial scale.

In other embodiments, the material for forming the cavities can include, but is not limited to, a perfluoropolyether material, a fluoroolefin material, an acrylate material, a silicone material, a styrenic material, a fluorinated thermoplastic elastomer (TPE), a triazine fluoropolymer, a perfluorocyclobutyl material, a fluorinated epoxy resin, and a fluorinated monomer or fluorinated oligomer that can be polymerized or crosslinked by a metathesis polymerization reaction.

In some embodiments, the fluoroolefin material is made from monomers which include tetrafluoroethylene, vinylidene fluoride, hexafluoropropylene, 2,2-bis(trifluoromethyl)-4,5-difluoro-1,3-dioxole, a functional fluoroolefin, functional acrylic monomer, and a functional methacrylic monomer. In some embodiments, the silicone material includes a fluoroalkyl functionalized polydimethylsiloxane (PDMS). In some embodiments, the styrenic material includes a fluorinated styrene monomer. In some embodiments, the acrylate material includes a fluorinated acrylate or a fluorinated methacrylate. In some embodiments, the triazine fluoropolymer includes a fluorinated monomer. In some embodiments, the fluorinated monomer or fluorinated oligomer that can be polymerized or crosslinked by a metathesis polymerization reaction includes a functionalized olefin. In some embodiments, the functionalized olefin includes a functionalized cyclic olefin. According to an alternative embodiment, the PFPE material includes a urethane block, such as PFPE urethane tetrafunctional methacrylate materials, that can be used as the materials for the molds of the present invention and with the methods of the present subject invention.

From a property point of view, the exact properties of these materials can be adjusted by adjusting the composition of the ingredients used to make the materials. In particular the modulus can be adjusted from low (approximately 1 MPa) to multiple GPa by varying the cross-link density, for example.

II. Formation of Isolated Micro- and/or Nano-Spacers

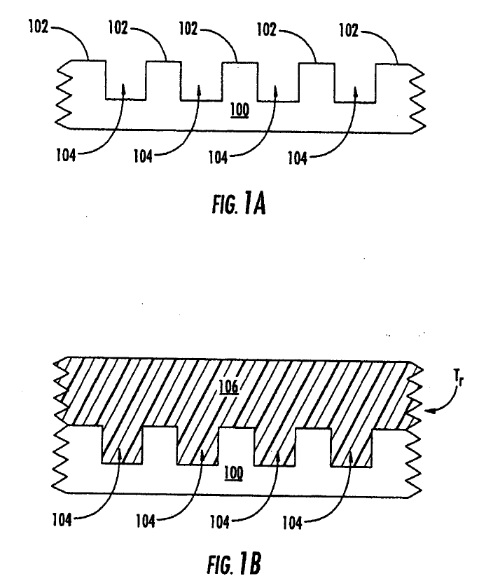

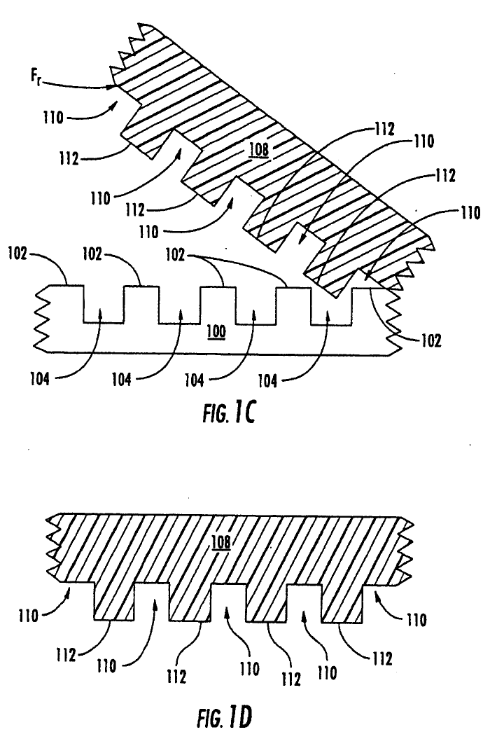

In some embodiments, the present subject matter provides methods, materials, and articles for making micro- and/or nano-spacers. Turning now to FIG. 1A, patterned master 100 is provided. Patterned master 100 includes a plurality of non-recessed surface areas 102 and a plurality of recesses or cavities 104. In some embodiments, patterned master 100 includes an etched substrate, such as a silicon wafer, which is etched or otherwise fabricated into a predetermined pattern.

Referring now to FIG. 1B, a liquid material 106, for example, a liquid fluoropolymer composition disclosed herein, such as a PFPE-based precursor, is then introduced onto patterned master 100. Liquid material 106 is treated by treating process Tr, for example exposure to UV light, actinic radiation, thermal exposure, or the like, (collectively referred to as photo-curable) thereby forming a treated liquid material or mold 108 in the desired pattern.

Referring now to FIGS. 1C and 1D, a force Fr is applied to treated liquid material, or mold 108, to remove it from patterned master 100. As shown in FIGS. 1C and 1D, mold 108 includes a plurality of cavities 110, which are mirror images of the plurality of non-recessed surface areas 102 of patterned master 100. Continuing with FIGS. 1C and 1D, mold 108 includes a plurality of first patterned surface areas 112, which are mirror images of the plurality of cavities 104 of patterned master 100. Accordingly, mold 108 can be used as a patterned template having cavities for which micro- and nano-spacers can be formed.

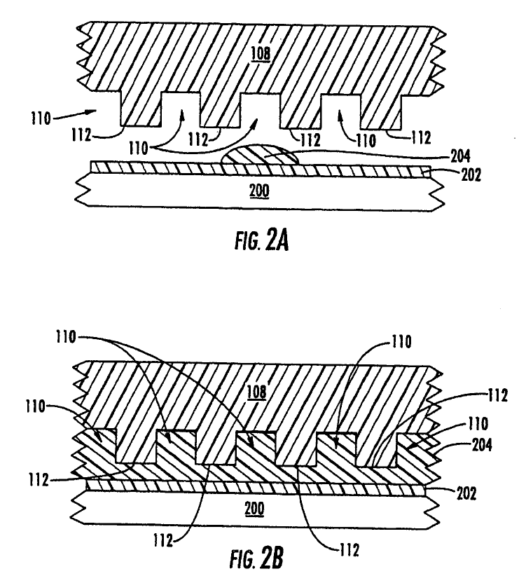

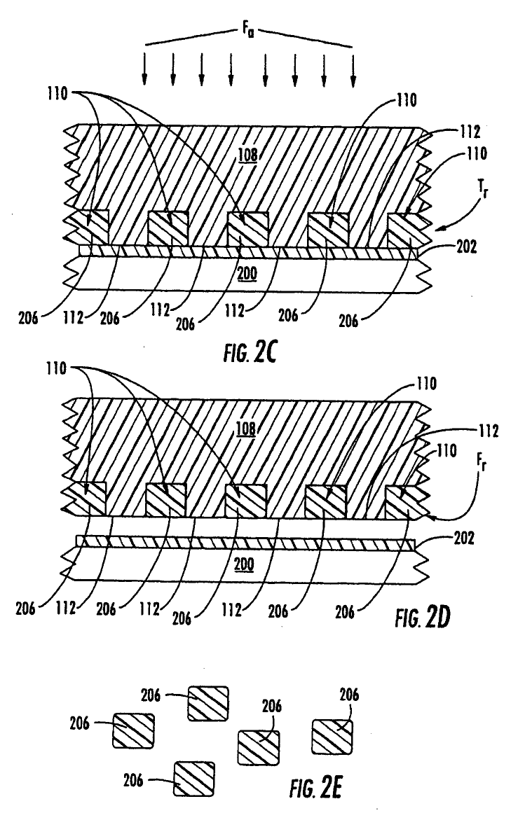

Referring now to FIGS. 2A and 2B, patterned template, or mold 108, is then contacted with droplet 204 of a spacer precursor material so that droplet 204 fills the plurality of cavities or recessed areas 110 of mold 108. Referring now to FIGS. 2C and 2D, a force Fa can be applied to mold 108. In some embodiments, as force Fa is applied force Fa causes droplet 204 to be excluded from all areas except for cavity areas 110. In some embodiments, a vacuum or other force can be applied to remove trapped gases from cavities 110 prior to introducing spacer precursor material 204 such that spacer precursor material 204 enters and/or completely fills cavities 110. In other embodiments, excess droplet material 204 can be used such that the material in the recessed cavities is interconnected. In yet other embodiments, mold 108 can be essentially free of non-wetting or low wetting material 202 such that when droplet 204 is contacted with the patterned template droplet material 204 wets the surface and a scum layer is formed that can interconnect the material in the recessed areas.

In other embodiments, mold 108 is contacted with droplet 204. The liquid material of droplet 204 then enters cavity areas 110 of mold 108. According to some embodiments, mechanical or physical manipulation of droplet 204 and mold 108 is provided to facilitate droplet 204 in substantially filling and conforming to cavity areas 110. Such mechanical and/or physical manipulation can include, but is not limited to, vibration, rotation, centrifugation, pressure differences, a vacuum environment, combinations thereof, or the like. Spacers 206 are formed in the cavity areas 110 of mold 108. In some embodiments, the mechanical force is applied by contacting one of a doctor blade and a brush with the one or more spacers. In some embodiments, the mechanical force is applied by ultrasonics, megasonics, electrostatics, or magnetics. In some embodiments, the force applied to remove trapped gas from cavities 110 and/or assist filling of cavities 110 with spacer precursor material can be selected from the group of vibration, rotation, agitation, sonication, vacuum, combinations thereof, or the like.

Continuing with FIGS. 2C and 2D, the spacer precursor material filling cavity areas 110 is then treated by a treating process Tr, e.g., photocured, UV-light treated, actinic radiation treated, evaporation, temperature change, centrifuged, phase change, chemical, physical, combinations thereof, or the like, to form a plurality of micro- and/or nano-spacers 206. In some embodiments, a material, including but not limited to a polymer, an organic compound, or an inorganic compound, can be dissolved in a solvent, patterned using mold 108, and the solvent can be released. Once the material filling cavities 110 is treated or hardened, mold 108 is removed from substrate 200. Micro- and/or nano-spacers 206 are confined to cavity areas 110 of mold 108. In some embodiments, micro- and/or nano-spacers 206 can be retained on substrate 200 in defined regions once mold 108 is removed.

Referring now to FIGS. 2D and 2E, micro- and/or nano-spacers 206 can be removed from mold 108 to provide freestanding spacers 206 by a variety of methods, which include but are not limited to: applying mold 108 to a surface that has an affinity for the spacers 206; deforming mold 108, or using other mechanical methods, including sonication or brushing, in such a manner that the spacers 206 are naturally released from mold 108; swelling mold 108 reversibly with supercritical carbon dioxide or another solvent that will extrude the spacers 206; washing mold 108 with a solvent that has an affinity for the spacers 206 and will wash them out of mold 108; applying mold 108 to a liquid that when hardened physically entraps spacers 206; applying mold 108 to a material that when hardened has a chemical and/or physical interaction with spacers 206; combinations thereof; and the like.

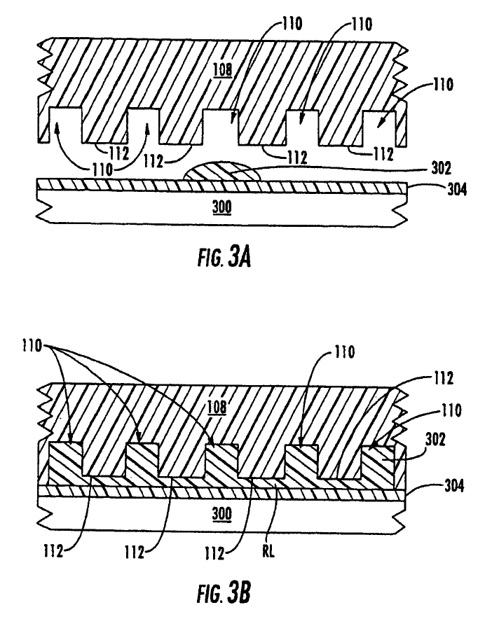

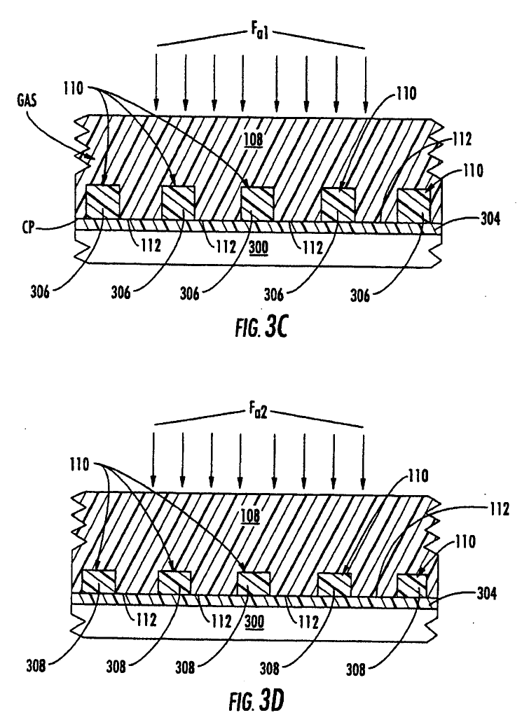

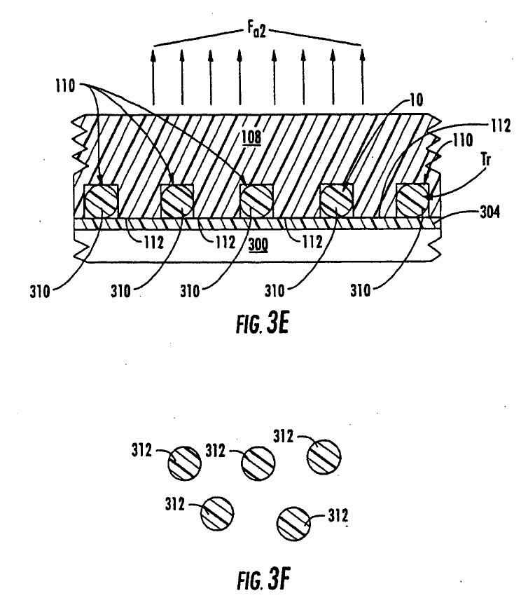

Referring now to FIGS. 3A through 3F, the present subject matter provides a “liquid reduction” process for forming spherical or substantially spherical spacers 312 in cavities of the mold, including but not limited to spherical and non-spherical, regular and non-regular micro- and nano-spacers. For example, a “cube-shaped” template cavity can allow for sphereical spacers to be made, whereas a “Block arrow-shaped” template cavity can allow for “lolli-pop” shaped spacers or objects to be made wherein the introduction of a gas allows surface tension forces to reshape the resident liquid prior to treating it. While not wishing to be bound by any particular theory, the non-wetting characteristics that can be provided in some embodiments of the presently disclosed mold and/or treated or coated substrate allows for the generation of rounded, e.g., spherical or substantially spherical spacers.

Referring now to FIG. 3A, droplet 302 of a liquid material is disposed on substrate 300. Substrate 300 can be a low-surface energy material or a material coated or treated with a substance that reduces adhesion to the material 304. A mold 108, which includes a plurality of cavity areas 110 and patterned surface areas 112, also is provided.

Referring now to FIG. 3B, mold 108 is contacted with droplet 302. The liquid droplet 302 then enters cavity areas 110 of mold 108. In some embodiments, a residual, or “scum,” layer RL of the liquid droplet 302 remains between the mold 108 and substrate 300.

Referring now to FIG. 3C, a first force Fa1 is applied to mold 108. A contact point CP is formed between the mold 108 and the substrate thereby displaces residual layer RL. Spacers 306 are formed in the cavity areas 110 of mold 108.

Referring now to FIG. 3D, a second force Fa2, wherein the force applied by Fa2 is greater than the force applied by Fa1, is then applied to mold 108, thereby forming smaller liquid spacers 308 inside recessed areas 112 and forcing a portion of the liquid droplet 302 out of recessed areas 112.

Referring now to FIG. 3E, second force Fa2 is released, thereby returning the contact pressure to the original contact pressure applied by first force Fa1. In some embodiments, mold 108 is gas permeable material which allows portions of droplet 302 to permeate through mold 108. Because mold 108 is non-wetting, droplet 302 forms a spherical or substantially spherical droplet 310. Once this liquid reduction is achieved, the plurality of liquid spherical droplets 310 are treated by a treating process Tr. Referring now to FIG. 3F, treated liquid spherical droplets 310 are released from mold 108 to provide a plurality of freestanding spherical spacers 312. In some embodiments, mold 108 includes a gas permeable material, which allows a portion of space with recessed areas 112 to be filled with a gas, such as nitrogen, thereby forming a plurality of liquid spherical droplets 310.

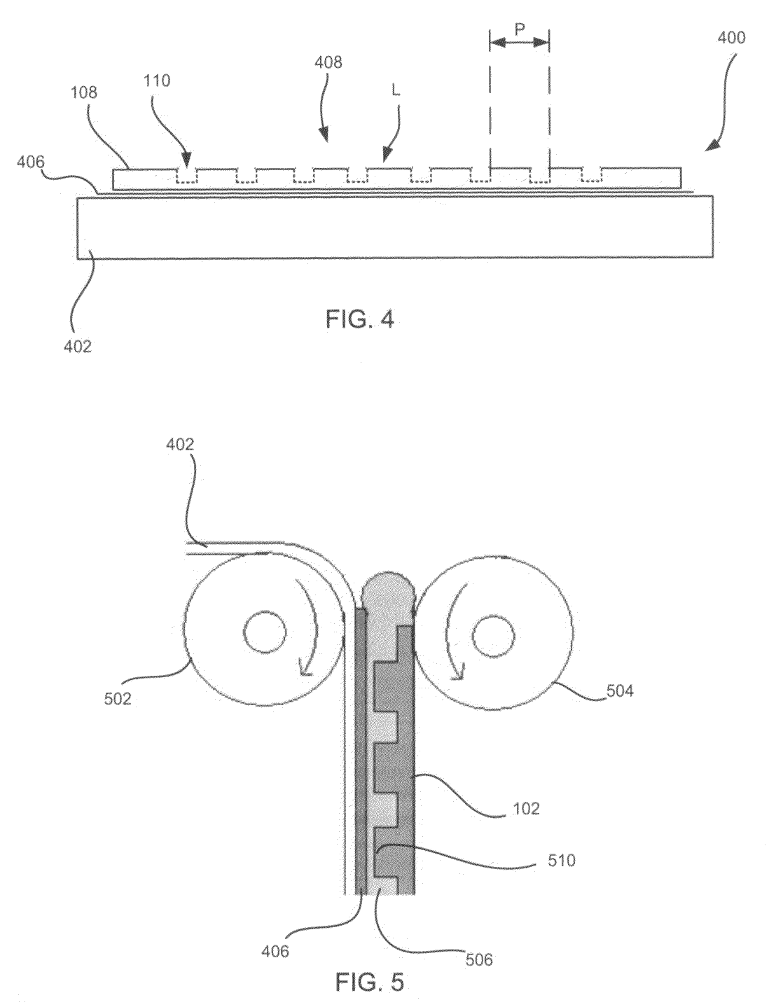

In some embodiments, as shown in FIG. 4, spacers 206 are fabricated from laminate molds, such as laminate mold 400 that includes a backing layer 402 affixed to a patterned mold layer 108 by a tie-layer 406. In certain embodiments, tie-layer 406 is used to bond patterned mold layer 108 to backing layer 402. According to some embodiments, patterned mold layer 108 includes a patterned surface 408. Patterned mold layer 108 can be made from the materials disclosed herein, the references incorporated herein by reference, and combinations thereof. According to some embodiments, patterned mold layer 108 includes a patterned surface 408. Patterned mold layer 108 can be made from the materials disclosed herein, and combinations thereof. Patterns on patterned surface 408 can include cavities 110 and land area L that extends between cavities 110. Patterns on patterned surface 408 can also include a pitch, such as pitch P, which is generally the distance from a first edge of one cavity to a first edge of an adjacent cavity including land area L between the adjacent cavities.

According to some embodiments, as shown in FIG. 5, laminate mold 400 is fabricated according to the methods and materials disclosed in U.S. patent application Ser. No. 11/633,763, filed on Dec. 4, 2006, which is incorporated herein by reference in its entirety. Referring to FIG. 5, polymer sheet backing 402 is pinched between two rollers 502, 504 adjacent a patterned master 102. As polymer sheet 402 and patterned master 102 are processed through rollers 502, 504, a curable liquid polymer 506 such as PFPE is introduced between an interface of polymer sheet 402 and patterned master 102. Pressure exerted by rollers 502 and 504 force liquid polymer 506 into surface features 510 of patterned master 102 such that surface features 510 are replicated on liquid polymer 506 layer. Next, a curing step cures liquid polymer 506 such that patterned structures 510 are affixed in the cured liquid polymer 506. In some embodiments, a tie layer 508 is configured between polymer backing 402 and cured liquid polymer layer 506, as described in the above referenced patent application.

Accordingly, cavities 110 for fabricating spacers according to the methods and materials of the present invention can be fabricated in the cured liquid polymer layer 506 of laminate mold 400.

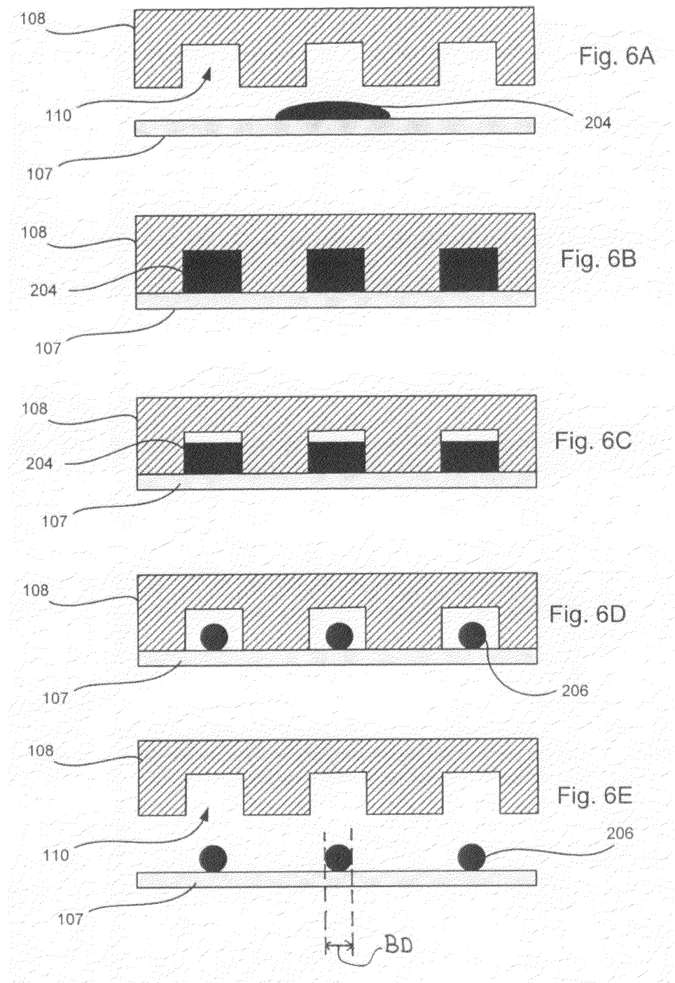

Referring now to FIGS. 6A-6E, an embodiment of the present subject matter includes a process for forming spacers through evaporation. In one embodiment, the process produces a spacer having a shape that does not necessarily conform to the shape of the cavity. The shape can include virtually any three dimensional shape. According to some embodiments, the spacer forms a spherical or non-spherical and regular or non-regular shaped micro- and nano-spacer. According to one embodiment, a spherical or substantially spherical spacer 206 can be formed by using a mold 108 and/or substrate 107 of a non-wetting material or treating the surfaces of the mold with a non-wetting agent such that the material from which the spacer will be formed does not wet the surfaces of the cavities of the mold. Because the material from which the spacer will be formed cannot wet the surfaces of the mold 108 and/or cavities 110 spacer material 204 has a greater affinity for itself than the surfaces of the cavities and thereby forms a rounded, curved, or substantially spherical shape.

Examples of an evaporative process that can be used with the present embodiments include forming mold 108 from a gas permeable material, which allows volatile components of the material to become the spacers to pass through the template, thereby reducing the volume of the material to become the spacers in the cavities. According to another embodiment, an evaporative process suitable for use with the presently disclosed subject matter includes providing a portion of the recessed cavities 110 filled with a gas, such as nitrogen, which thereby increases the evaporation rate of the material to become the spacers. According to further embodiments, after the cavities are filled with material to become the spacers, a space can be left between the mold and substrate such that evaporation is enhanced. In yet another embodiment, the combination of the mold, substrate, and material to become the spacer can be heated or otherwise treated to enhance evaporation of the material to become the spacer.

According to some embodiments, the spacers described herein are formed in an open mold. Open molding can reduce the number of steps and sequences of events required during molding of spacers and additionally can improve the evaporation rate of solvent from the spacer precursor material, thereby, increasing the efficiency and rate of spacer production.

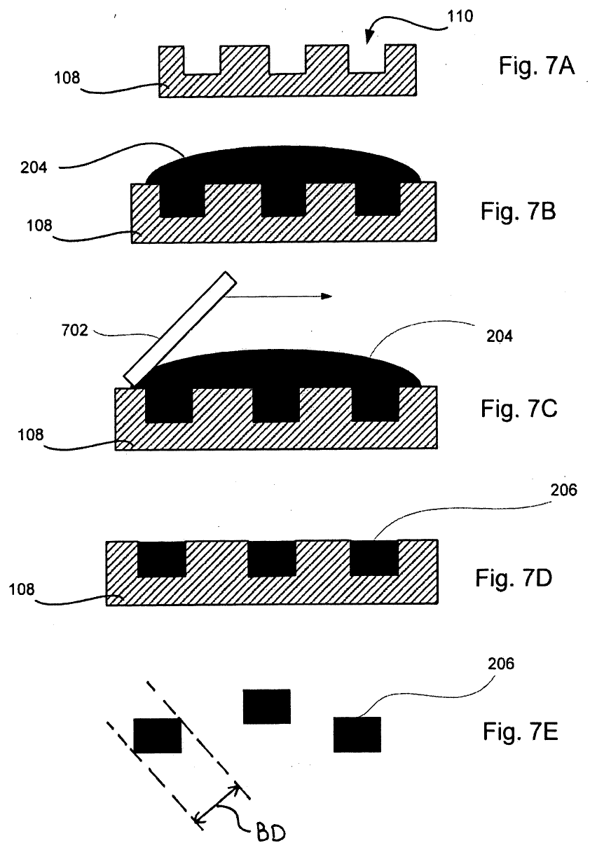

Referring to FIG. 7, surface or mold 108 includes cavities 110 formed therein. A substance 204, which can be, but is not limited to a liquid, a powder, a paste, a gel, a liquified solid, combinations thereof, and the like, is then deposited on surface of mold 108. The substance 204 is introduced into cavities 110 of mold 108 and excess substance remaining on surface of mold 108 is removed by an active process or by a passive material property process 702. According to some embodiments of active process removal, excess substance 204 can be removed from the surface by, doctor blading 702, applying pressure with a substrate, capillary forces, electrostatics, magnetic forces, gravitational forces, air pressure, combinations thereof, and the like. In alternative embodiments, the physical and chemical properties of the materials, i.e., non-wetting low surface energy properties, can result in a passive process for ridding the surface of excess spacer material. Next, substance 204 remaining in cavities 110 is hardened into spacers 206 by, but is not limited to, photocuring, thermal curing, solvent evaporation, oxidation or reductive polymerization, change of temperature, combinations thereof, and the like. After substance 204 is hardened, the spacers 206 are harvested from cavities 110.

According to some embodiments, mold 108 is configured such that spacer fabrication is accomplished in high throughput. In some embodiments, the surface is configured, for example, planer, cylindrical, spherical, curved, linear, a conveyer belt type arrangement, a gravure printing type arrangement, in large sheet arrangements, in multi-layered sheet arrangements, combinations thereof, and the like.

III. Micro and Nano-Spacers

According to some embodiments of the present subject matter, a spacer is formed having a predetermined shape, size, formulation, density, composition, surface features, spectral analysis, modulus, hardness, or the like and can be less than about 200 μm in a given dimension (e.g. minimum, intermediate, or maximum dimension). In some embodiments, spacer 206 is measured in the broadest dimension BD, as shown in FIGS. 6E and 7E. In some embodiments, the spacer is less than about 500 μm in a broadest dimension. In some embodiments, the spacer is less than about 450 μm in a broadest dimension. In some embodiments, the spacer is less than about 400 μm in a broadest dimension. In some embodiments, the spacer is less than about 350 μm in a broadest dimension. In some embodiments, the spacer is less than about 300 μm in a broadest dimension. In some embodiments, the spacer is less than about 250 μm in a broadest dimension. In some embodiments, the spacer is less than about 200 μm in a broadest dimension. In some embodiments, the spacer is less than about 150 μm in a broadest dimension. In some embodiments, the spacer is less than about 100 μm in a broadest dimension. In some embodiments, the spacer is less than about 75 μm in a broadest dimension. In some embodiments, the spacer is less than about 50 μm in a broadest dimension. In some embodiments, the spacer is less than about 40 μm in a broadest dimension. In some embodiments, the spacer is less than about 30 μm in a broadest dimension. In some embodiments, the spacer is less than about 20 μm in a broadest dimension. In some embodiments, the spacer is less than about 5 μm in a broadest dimension. In some embodiments, the spacer is less than about 1 μm in a broadest dimension. In some embodiments, the spacer is less than about 900 nm in a broadest dimension. In some embodiments, the spacer is less than about 800 nm in a broadest dimension. In some embodiments, the spacer is less than about 700 nm in a broadest dimension. In some embodiments, the spacer is less than about 600 nm in a broadest dimension. In some embodiments, the spacer is less than about 500 nm in a broadest dimension. In some embodiments, the spacer is less than about 400 nm in a broadest dimension. In some embodiments, the spacer is less than about 300 nm in a broadest dimension. In some embodiments, the spacer is less than about 200 nm in a broadest dimension. In some embodiments, the spacer is less than about 100 nm in a broadest dimension. In some embodiments, the spacer is less than about 80 nm in a broadest dimension. In some embodiments, the spacer is less than about 75 nm in a broadest dimension. In some embodiments, the spacer is less than about 70 nm in a broadest dimension. In some embodiments, the spacer is less than about 65 nm in a broadest dimension. In some embodiments, the spacer is less than about 60 nm in a broadest dimension. In some embodiments, the spacer is less than about 55 nm in a broadest dimension. In some embodiments, the spacer is less than about 50 nm in a broadest dimension. In some embodiments, the spacer is less than about 45 nm in a broadest dimension. In some embodiments, the spacer is less than about 40 nm in a broadest dimension. In some embodiments, the spacer is less than about 35 nm in a broadest dimension. In some embodiments, the spacer is less than about 30 nm in a broadest dimension. In some embodiments, the spacer is less than about 25 nm in a broadest dimension. In some embodiments, the spacer is less than about 20 nm in a broadest dimension. In some embodiments, the spacer is less than about 15 nm in a broadest dimension. In some embodiments, the spacer is less than about 10 nm in a broadest dimension. In some embodiments, the spacer is less than about 7 nm in a broadest dimension. In some embodiments, the spacer is less than about 5 nm in a broadest dimension. In some embodiments, the spacer is less than about 2 nm in a broadest dimension. In some embodiments, the spacer is less than about 0.5 nm in a broadest dimension. In some embodiments, the spacer is less than about 0.1 nm in a broadest dimension. The spacer can be of an organic material or an inorganic material or a composite and can be one uniform compound or component or a mixture of compounds or components.

According to some embodiments, the spacer includes a broadest dimension between about 0.5 μm and about 10 μm. In another embodiment, the spacer includes a broadest dimension between about 1 μm and about 7 μm. In another embodiment, the spacer includes a broadest dimension between about 1.5 μm and about 5 μm. In another embodiment, the spacer includes a broadest dimension between about 2 μm and about 4 μm. In another embodiment, the spacer includes a broadest dimension between about 2.5 μm and about 3.5 μm.

According to other embodiments, the spacers produced by the methods and materials of the present subject matter have substantially the same size and/or three-dimensional geographic shape such that the variation between the spacers is minimal and a collection of the spacers are substantially monodisperse. In some embodiments, the polydispersity in the broadest dimension of the spacers is calculated at 1.0005. In some embodiments, the polydispersity in the broadest dimension of the spacers is less than about 1.0006. In some embodiments, the polydispersity in the broadest dimension of the spacers is less than about 1.0008. In some embodiments, the polydispersity in the broadest dimension of the spacers is less than about 1.0010.

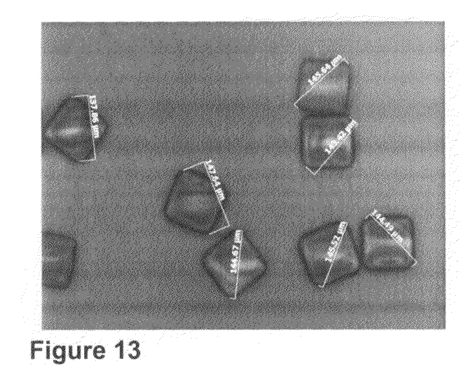

In some embodiments, spacer size distribution data can be obtained by measuring the diagonal lengths of a given population of particles in a series of micrographs. For example, a sample having ˜1 mg of purified 110 μm×110 μm×50 μm spacers on a glass microscope slide can be positioned with a second microscope slide on top to sandwich the spacers. Moving the slides back and forth with the spacers in between can orient the spacers in the same plane. Microscope software with a calibrated measure function can then be used to measure the longest particle dimension, as shown in FIG. 13. Polydispersity of spacer lengths can be calculated using equations typically used in calculating polydispersity of polymer chains. In particular, the following equation can be used:

Polydipsersity=Mw/Mn=(1+δ²/Mn²)

where Mw is the weight average length, Mn is the number average length, and 6 is the standard deviation as described by Sheu, et al. in Journal of Chemical Education Vol 78, No. 4 Apr. 2001 and which is incorporated herein by reference. A polydispersity of 1.0005 was calculated in this manner for a population of 26, 110 μm×110 μm×50 μm spacers, of the present invention.

In other embodiments, the spacers differ in size and/or shape from each other by less than about 0.005 percent. In other embodiments, the spacers differ in size and/or shape from each other by less than about 0.01 percent. In other embodiments, the spacers differ in size and/or shape from each other by less than about 0.05 percent. In other embodiments, the spacers differ in size and/or shape from each other by less than about 0.1 percent. In other embodiments, the spacers differ in size and/or shape from each other by less than about 0.5 percent. In other embodiments, the spacers do not differ in size and/or shape from each other.

According to other embodiments, spacers of many predetermined regular and irregular shape and size configurations can be made with the materials and methods of the presently disclosed subject matter. Examples of representative shapes that can be made using the materials and methods of the presently disclosed subject matter include, but are not limited to, non-spherical, spherical, cubed, cylindrical, viral shaped, bacteria shaped, cell shaped, rod shaped (e.g., where the rod is less than about 200 nm in diameter), chiral shaped, right triangle shaped, flat shaped (e.g., with a thickness of about 2 nm, disc shaped with a thickness of greater than about 2 nm, or the like), boomerang shaped, combinations thereof, and the like.

In other embodiments, the predetermined geometric shape of the spacer has two substantially flat and substantially parallel sides. In alternate embodiments, the predetermined geometric shape of the spacer includes a predetermined radius of curvature, a predetermined angle between two sides of the spacer, a cuboidal shape, a conical shape, a spherical shape, a cylindrical shape, a rectangular shape, a cube shape, a cone shape, a sphere shape, a cylinder shape, a rectangle shape, combinations thereof, and the like. In some embodiments the predetermined geometric shape includes a predetermined radius of curvature. In other embodiments the predetermined geometric shape includes a substantially flat surface having a predetermined width, a substantially flat surface having a predetermined width, or two substantially flat surfaces, where the two substantially flat surfaces abut with a predetermined angle. In some embodiments, the spacer is integral with a film layer, positioned in a predetermined location with respect to a film, or each spacer of the plurality of spacers is coupled in a predetermined location on a film. In some embodiments, the film includes a first composition and the spacer includes a second composition. In some embodiments, the film and the spacer include the same composition.

IV. Spacer Compositions

According to the present invention, spacers 206 can be formed from a wide variety of materials. In some embodiments, the material from which the spacers are formed includes, without limitation, one or more of a polymer, a liquid polymer, a solution, a monomer, a plurality of monomers, a polymerization initiator, a polymerization catalyst, an inorganic precursor, an organic material, a natural product, a metal, a magnetic material, a paramagnetic material, a superparamagnetic material, a porogen, a surfactant, a plurality of immiscible liquids, a solvent, a charged species, a biological material, a radioactive material, a conducting material, an electron donating material, and electron accepting material, a material with a high refractive index, a material with a low refractive index, a material containing an optical sensor, combinations thereof, or the like. In other embodiments, the spacers can be formed from glass, silicate glass, alumina, divinylbenzene-contained cross-linked polymer, polystyrene-contained cross-linked polymer, polysiloxane, organic cross-linked polymers, organic-inorganic-composites, conducting materials, combinations thereof, or the like. In some embodiments, the spacers are formed from compositions that do not substantially become deformed by heat or pressure. In other embodiments, the material for forming the spacers includes a colored material, a clear material, an opaque material, predetermined optical properties, a reflective material, combinations thereof, and the like. In some embodiments, the spacers include textured surfaces that can, in some embodiments, alter or tune optical properties of the spacers.

According to some embodiments, the compositions for forming spacers is selected based on desired properties of the spacer 206 including parameters such as modulus of elasticity, density, hardness, conductivity, heat resistance, constant volume, light handling (i.e., reflective, refractive, opacity, translucency, focusing, or the like), combinations thereof, and the like. In some embodiments, a density of the finished spacer can be adjusted to range from about 25 pcs/sq.mm to about 500 pcs/sq.mm. In some embodiments the density of the finished spacer ranges from about 50 pcs/sq.mm to about 400 pcs/sq.mm. In some embodiments the density of the finished spacer ranges from about 75 pcs/sq.mm to about 300 pcs/sq.mm. In some embodiments the density of the finished spacer ranges from about 100 pcs/sq.mm to about 200 pcs/sq.mm.

Representative superparamagnetic or paramagnetic materials include but are not limited to Fe2O3, Fe3O4, FePt, Co, MnFe2O4, CoFe2O4, CuFe2O4, NiFe2O4 and ZnS doped with Mn for magneto-optical applications, CdSe for optical applications, and borates for boron neutron capture treatment. In some embodiments, the liquid material is selected from one of a resist polymer and a low-k dielectric. In some embodiments, the liquid material includes a non-wetting agent.

In some embodiments, the monomer includes butadienes, styrenes, propene, acrylates, methacrylates, vinyl ketones, vinyl esters, vinyl acetates, vinyl chlorides, vinyl fluorides, vinyl ethers, acrylonitrile, methacrylnitrile, acrylamide, methacrylamide allyl acetates, fumarates, maleates, ethylenes, propylenes, tetrafluoroethylene, ethers, isobutylene, fumaronitrile, vinyl alcohols, acrylic acids, amides, carbohydrates, esters, urethanes, siloxanes, formaldehyde, phenol, urea, melamine, isoprene, isocyanates, epoxides, bisphenol A, alcohols, chlorosilanes, dihalides, dienes, alkyl olefins, ketones, aldehydes, vinylidene chloride, anhydrides, saccharide, acetylenes, naphthalenes, pyridines, lactams, lactones, acetals, thiiranes, episulfide, peptides, derivatives thereof, and combinations thereof.

In yet other embodiments, the polymer includes polyamides, proteins, polyesters, polystyrene, polyethers, polyketones, polysulfones, polyurethanes, polysiloxanes, polysilanes, cellulose, amylose, polyacetals, polyethylene, glycols, poly(acrylate)s, poly(methacrylate)s, poly(vinyl alcohol), poly(vinylidene chloride), poly(vinyl acetate), poly(ethylene glycol), polystyrene, polyisoprene, polyisobutylenes, poly(vinyl chloride), poly(propylene), poly(lactic acid), polyisocyanates, polycarbonates, alkyds, phenolics, epoxy resins, polysulfides, polyimides, liquid crystal polymers, heterocyclic polymers, polypeptides, conducting polymers including polyacetylene, polyquinoline, polyaniline, polypyrrole, polythiophene, and poly(p-phenylene), dendimers, fluoropolymers, derivatives thereof, combinations thereof,

In still further embodiments, the material from which the spacers are formed includes a non-wetting agent. According to another embodiment, the material is a liquid material in a single phase. In other embodiments, the liquid material includes a plurality of phases. In some embodiments, the liquid material includes, without limitation, one or more of multiple liquids, multiple immiscible liquids, surfactants, dispersions, emulsions, micro-emulsions, micelles, particulates, colloids, porogens, active ingredients, combinations thereof, or the like.

In some embodiments, additional components are included with the material of the spacer to functionalize the spacer. According to these embodiments the additional components can be encased within the isolated structures, partially encased within the isolated structures, on the exterior surface of the isolated structures, combinations thereof, or the like. Additional components can include, but are not limited to, biological molecules, polymers, monomers, crystals, inorganic materials, metals, ceramics, conducting materials, electron donating materials, electron accepting materials, combinations thereof, and the like.

In some embodiments, the spacer includes a biodegradable polymer. In other embodiments, the polymer is modified to be a biodegradable polymer (e.g., a poly(ethylene glycol) that is functionalized with a disulfide group). In some embodiments, the biodegradable polymer includes, without limitation, one or more of a polyester, a polyanhydride, a polyamide, a phosphorous-based polymer, a poly(cyanoacrylate), a polyurethane, a polyorthoester, a polydihydropyran, a polyacetal, combinations thereof, or the like. In some embodiments, the polyester includes, without limitation, one or more of polylactic acid, polyglycolic acid, poly(hydroxybutyrate), poly(ε-caprolactone), poly(β-malic acid), poly(dioxanones), combinations thereof, or the like. In some embodiments, the polyanhydride includes, without limitation, one or more of poly(sebacic acid), poly(adipic acid), poly(terpthalic acid), combinations thereof, or the like. In yet other embodiments, the polyamide includes, without limitation, one or more of poly(imino carbonates), polyaminoacids, combinations thereof, or the like.

According to some embodiments, the phosphorous-based polymer includes, without limitation, one or more of a polyphosphate, a polyphosphonate, a polyphosphazene, combinations thereof, or the like. Further, in some embodiments, the biodegradable polymer further includes a polymer that is responsive to a stimulus. In some embodiments, the stimulus includes, without limitation, one or more of pH, radiation, ionic strength, oxidation, reduction, temperature, an alternating magnetic field, an alternating electric field, combinations thereof, or the like. In some embodiments, the stimulus includes an alternating magnetic field.

V. Harvesting

Before using spacers 206 formed in cavities 110 of molds or mold 108, the spacers 206 must, in many embodiments, be removed or harvested from cavities 110. Harvesting can be accomplished by a number of approaches, including but not limited to applying a surface, film, substance, or the like, i.e., harvesting material, to mold 108 containing spacers 206 where the harvesting material has an affinity for spacer 206 that is greater than the affinity between spacer 206 and mold 108. In some embodiments, the harvesting material is a substance that can be hardened when in contact with spacers 206 to form a chemical and/or physical interaction with spacer 206. In other embodiments, mold 108 can be swelled such that spacers 206 contained within cavities 110 of mold 208 are released from cavities 110.

In some embodiments, the harvesting material can be a liquid, such as, water that is cooled to form ice while in contact with spacers 206. In some embodiments, the water is cooled to a temperature below the Tm of water but above the Tg of spacer 206. In some embodiments, the water is cooled to a temperature below the Tg of spacers 206 but above the Tg of mold 108. In some embodiments, the water is cooled to a temperature below the Tg of mold 108 or spacer 206. In alternative embodiments, the liquid harvesting material can be supercritical fluid carbon dioxide or an aqueous solution including water and a detergent.

In other embodiments, physical force, vacuum, vibration, sonication, temperature variation, combinations thereof, and the like, can be used to harvest spacers 206 from cavities 110 of molds 108.

In some embodiments, the harvesting methods include a process selected from the group including scraping with a doctor blade, a brushing process, a dissolution process, an ultrasound process, a megasonics process, an electrostatic process, and a magnetic process. In some embodiments, the harvesting or collecting of spacers 206 includes applying a material to at least a portion of spacer 206 wherein the material has an affinity for spacers 206. In some embodiments, the material includes an adhesive or sticky surface. In some embodiments, the material includes, without limitation, one or more of a carbohydrate, an epoxy, a wax, polyvinyl alcohol, polyvinyl pyrrolidone, polybutyl acrylate, a polycyano acrylate, a polyacrylic acid and polymethyl methacrylate.

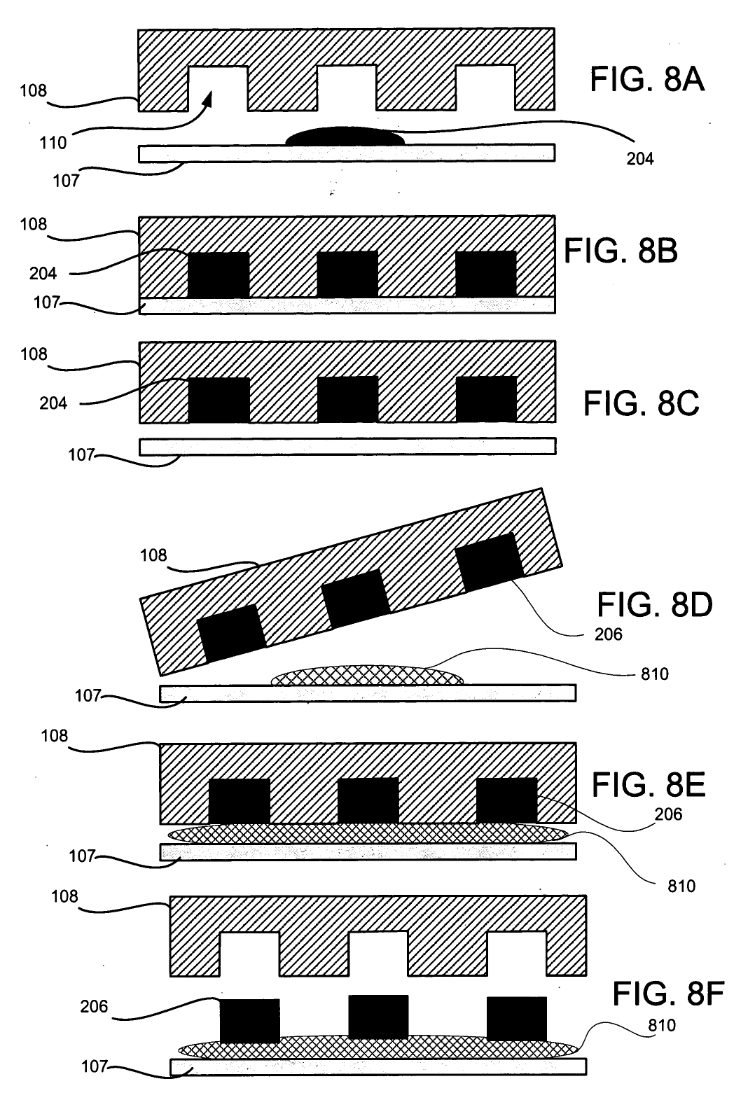

Spacer harvesting methods are now described with respect to FIGS. 8D-8F. According to FIGS. 8A-8C, spacers 206 are formed in cavities 110 of mold 108 according to other embodiments described herein and in references cited and incorporated herein by reference. After spacers 206 are fabricated in cavities 110 of mold 108, spacers 206 are contacted with harvesting material 810, as shown in FIG. 8D. As the combination of mold 108 and spacer 206 comes into contact with harvesting material 810, harvesting material 810 is distributed across mold 108 and contacts the plurality of spacers 206 by being pinched between mold 108 and backing 107, as shown in FIG. 8E. In some embodiments, harvesting material has a greater affinity for spacers 206 than an affinity between spacers 206 and mold 108, thereby; spacers 206 remain in contact with harvesting material 810 when mold 108 is removed, as shown in FIG. 8F. According to some embodiments, harvesting material 810 can be an adhesive, a liquid, water, a monomer, a polymer, a biodegradable substance, combinations thereof, or the like.

In one embodiment harvesting material 810 has an affinity for spacers 206. For example, in some embodiments, harvesting material 810 includes an adhesive or sticky surface or film. In other embodiments, harvesting material 810 undergoes a transformation after it is brought into contact spacers 206. In some embodiments that transformation is an inherent characteristic of harvesting material 810. In other embodiments, harvesting material 810 is treated to induce the transformation. For example, in one embodiment harvesting material 810 is an epoxy that hardens after it is brought into contact with spacers 206. Thus when harvesting material 810 is pealed away from backing 107, spacers 206 remain engaged with the epoxy and not backing 107. In other embodiments, harvesting material 810 is water that is cooled to form ice. Thus, when backing 107 is stripped from the ice, spacers 206 remain in communication with the ice and not backing 107. In one embodiment, the spacer-containing ice can be melted to create a liquid with a concentration of spacers 206. In some embodiments, harvesting material 810 include, without limitation, one or more of a carbohydrate, an epoxy, a wax, polyvinyl alcohol, polyvinyl pyrrolidone, polybutyl acrylate, a polycyano acrylate and polymethyl methacrylate. In some embodiments, harvesting material 810 includes, without limitation, one or more of liquids, solutions, powders, granulated materials, semi-solid materials, suspensions, films, combinations thereof, or the like.

According to yet another embodiment spacers 206 are harvested on a fast dissolving substrate, sheet, or films. The film-forming agents can include, but are not limited to pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, xanthan gum, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, combinations thereof, and the like. In some embodiments, pullulan is used as the primary filler. In still other embodiments, pullulan is included in amounts ranging from about 0.01 to about 99 wt %, preferably about 30 to about 80 wt %, more preferably from about 45 to about 70 wt %, and even more preferably from about 60 to about 65 wt % of the film.

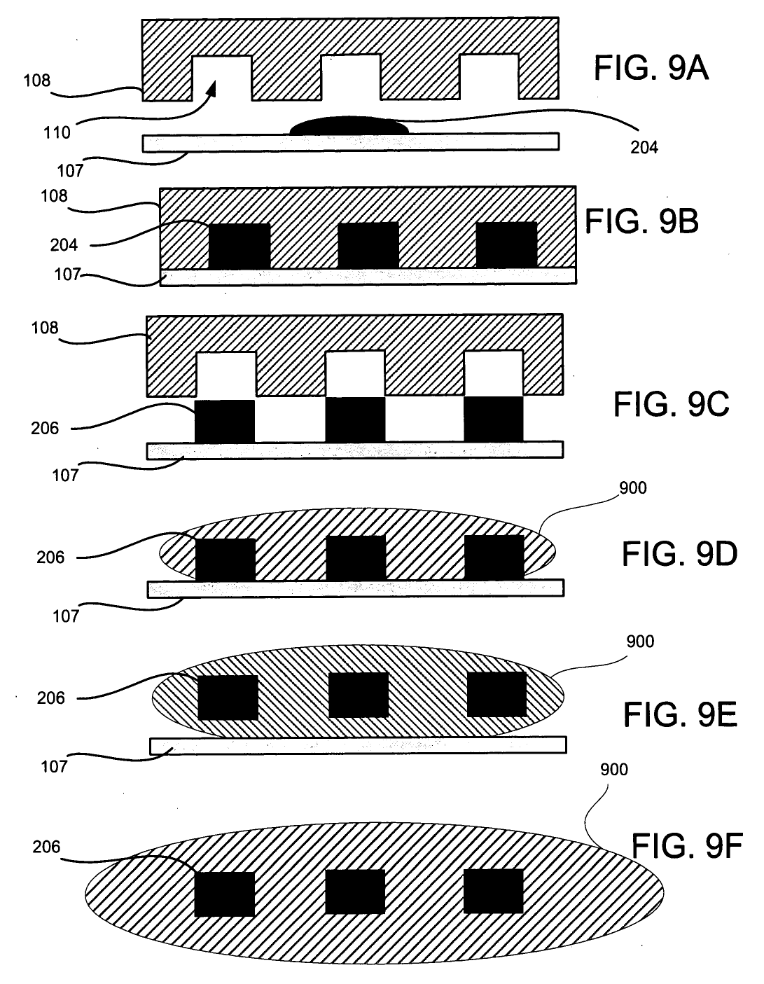

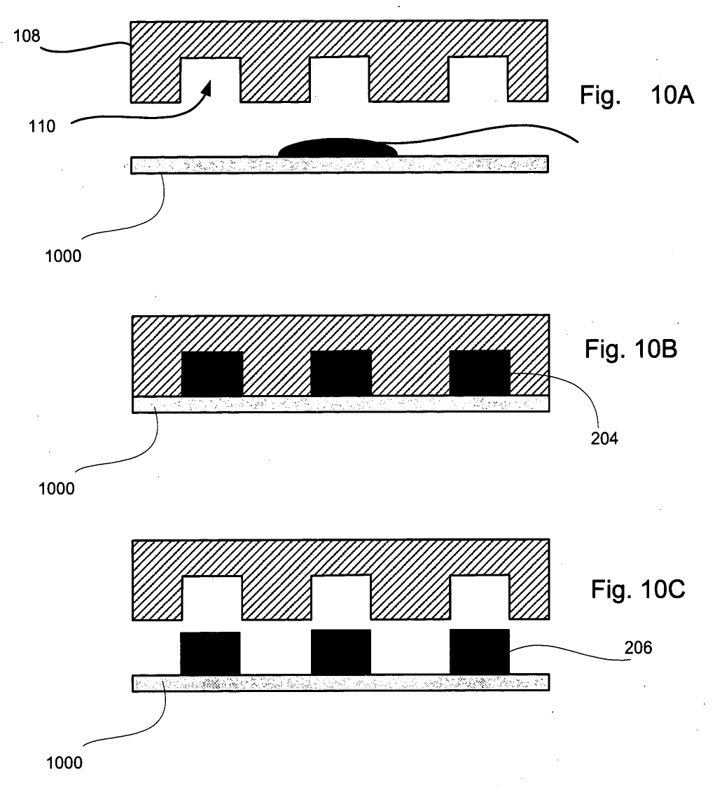

Referring now to FIGS. 9A-9F, spacers 206 are formed in mold 108 cavities 110 according to other embodiments described herein and in references cited and incorporated herein by reference. After spacers 206 are fabricated in cavities 110 of mold 108 (FIGS. 9A-9C), harvesting solution 900 is introduced to spacers 206, as shown in FIG. 9D. In some embodiments, harvesting solution 900 can be any composition into which spacers 206 can go into solution with or disassociate from backing 107, such as shown in FIGS. 9E and 9F. It will be appreciated that depending on the composition of spacers 206, the composition of harvesting solution 900 will vary; however, such selection is within the understanding of one skilled in the art. Thereafter, spacers 206, being in solution with harvesting solution 900 can be utilized and introduced to a predetermined application.

According to other embodiments, spacers 206 are harvested by subjecting the spacer/cavity combination to a physical force or energy such that spacers 206 are released from the cavities 110. In some embodiments the force is, but is not limited to, centrifugation, dissolution, vibration, ultrasonics, megasonics, gravity, flexure of the template, suction, electrostatic attraction, electrostatic repulsion, magnetism, physical template manipulation, combinations thereof, and the like.

According to some embodiments, spacers 206 are purified after being harvested. In some embodiments spacers 206 are purified from the harvesting substance. The harvesting can be, but is not limited to, centrifugation, separation, vibration, gravity, dialysis, filtering, sieving, electrophoresis, gas stream, magnetism, electrostatic separation, combinations thereof, and the like.

According to some embodiments, the harvesting substance is, but is not limited to, water, organic solvents, carbohydrates, epoxies, waxes, polyvinyl alcohol, polyvinyl pyrrolidone, polybutyl acrylate, polycyano acrylates, polymethyl methacrylate, a porogen, combinations thereof, and the like.

VI. Spacers on a Film

In some embodiments, the present invention includes fabricating or harvesting spacers on a film or sacrificial layer, as shown in FIGS. 10A-10C and/or 11A-11C. In some embodiments, as shown in FIGS. 10A-10B, spacers 206 are fabricated according to methods and materials described herein, however, spacers 206 are fabricated or harvested on film 1000. In some embodiments, film 1000 includes but is not limited to a film that is dissolvable, resorbable, sacrificial, or the like. According to such embodiments, cavities 110 of mold 108 are arranged according to a predetermined arrangement that coincides with how spacers 206 are to be positioned with respect to each other for a particular application.

Because spacers 206 are typically less than about 250 micrometers they can be difficult to handle and place with precision in a device of interest. However, when spacers 206 are harvested on film 1000, film 1000 can have a size on the scale of square millimeters, centimeters, or larger and therefore, be easily manipulated to a precise predetermined location and, in effect, provide precise predetermined placement of micro or nano sized spacers 206. In other embodiments, film 1000 can be a component of a device and spacers 206 can be harvested directly onto that device and accordingly be precisely positioned for utilization.

As described above, because of the small overall dimension of spacers 206 for many applications, such as but not limited to optical devices or uses, electronic devices or uses, precision machinery, and the like, fabricating spacers 206 on or releasable attached to a spacer layer 1100 can greatly increase precision manipulability of the micro and nano-spacers. Spacers 206 can be precisely located with respect to each other and positioned in a predetermined organization by fabricating cavities 110 of mold 108 in predetermined locations. Thereafter, when spacers 206 are fabricated in the prearranged cavities 110 of mold 108 and spacers 206 are harvested onto a surface or film, spacers 206 retain their predetermine relationship with respect to each other and can be applied to a desired device with such prearranged relationship.

In some embodiments, spacer placement with respect to each other and with respect to location in a device can include a predetermined randomness. A predetermined randomness of spacer location can be introduced to the manufacturing of a device by either selecting a random organization of the cavities of the mold or selecting a random offset between placement of the surface or film that contains the harvested spacers and the device to be spaced. In some embodiments, determining the predetermined randomness of spacer organization can be accomplished by utilizing a mathematical algorithm to generate a random distribution or spacing. In some embodiments, predetermined random distribution or location of spacers can enhance proper placement of spacers within a device and decrease a likelihood that spacers will be predominately in positions to interfere with operation of a device such as an LCD.

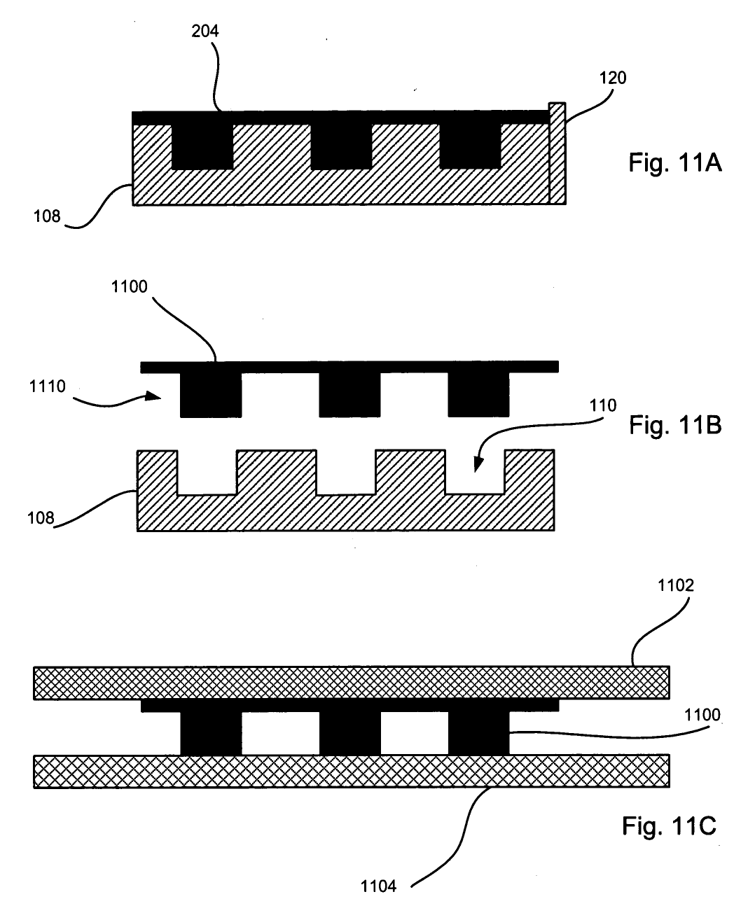

According to yet another embodiment, spacers 206 can be fabricated as an integral spacer layer 1100, as shown in FIGS. 11A-11C. According to FIG. 11A, a mold 108 can be communicated with spacer precursor 204 such that spacer precursor material 204 fills cavities 110 in mold 108 and interconnects spacer precursor material 204 in cavities 110. In some embodiments, spacer precursor material 204 can coat the surface of mold 108. In other embodiments, mold 108 can have raised edges 120 or retained in a housing that allows for spacer precursor material 204 to form a layer over the surface of mold, as shown in FIG. 11A. Spacer layer 1100 is fabricated and removed from mold as described herein, in the references incorporated by reference, and as will be appreciated by one of ordinary skill in the art. Next, spacer layer 1100 can be positioned between first component 1102 and second component 1104 of a device to be spaced apart, as shown in FIG. 11C.

According to some embodiments, spacer posts 1110 of spacer layer 1100 can be 200 micrometers high or less and interconnected by a layer 200 micrometers or less, thereby, generating a spacer layer 1100 that can space a gap of 400 micrometers or less. According to some embodiments, spacer posts 1110 of spacer layer 1100 can be 150 micrometers high or less and interconnected by a layer 150 micrometers or less, thereby, generating a spacer layer 1100 that can space a gap of 300 micrometers or less. According to some embodiments, spacer posts 1110 of spacer layer 1100 can be 100 micrometers high or less and interconnected by a layer 100 micrometers or less, thereby, generating a spacer layer 1100 that can space a gap of 200 micrometers or less. According to some embodiments, spacer posts 1110 of spacer layer 1100 can be 50 micrometers high or less and interconnected by a layer 50 micrometers or less, thereby, generating a spacer layer 1100 that can space a gap of 100 micrometers or less. According to some embodiments, spacer posts 1110 of spacer layer 1100 can be 200 micrometers high or less and interconnected by a layer 50 micrometers or less, thereby, generating a spacer layer 1100 that can space a gap of 250 micrometers or less. According to some embodiments, spacer posts 1110 of spacer layer 1100 can be 75 micrometers high or less and interconnected by a layer 25 micrometers or less, thereby, generating a spacer layer 1100 that can space a gap of 100 micrometers or less. According to some embodiments, spacer posts 1110 of spacer layer 1100 can be 50 micrometers high or less and interconnected by a layer 50 micrometers or less, thereby, generating a spacer layer 1100 that can space a gap of 100 micrometers or less. According to some embodiments, spacer posts 1110 of spacer layer 1100 can be 10 micrometers high or less and interconnected by a layer 10 micrometers or less, thereby, generating a spacer layer 1100 that can space a gap of 20 micrometers or less. According to some embodiments, spacer posts 1110 of spacer layer 1100 can be 1 micrometer high or less and interconnected by a layer 1 micrometer or less, thereby, generating a spacer layer 1100 that can space a gap of 2 micrometers or less. According to some embodiments, spacer posts 1110 of spacer layer 1100 can be 206 nanometers high or less and interconnected by a layer 206 nanometers or less, thereby, generating a spacer layer 1100 that can space a gap of 1 micrometer or less. According to some embodiments, spacer posts 1110 of spacer layer 1100 can be 250 nanometers high or less and interconnected by a layer 250 nanometers or less, thereby, generating a spacer layer 1100 that can space a gap of 206 nanometers or less. According to some embodiments, spacer posts 1110 of spacer layer 1100 can be 100 nanometers high or less and interconnected by a layer 100 nanometers or less, thereby, generating a spacer layer 1100 that can space a gap of 200 nanometers or less. It will be appreciated that the thickness of the spacer, spacer post, and layer can be adjusted to satisfy the needs of a given application, however, the combinations of which are too numerous to list in this application but are within the scope of the present invention.

For example, a particular application of the present invention may be fabricating a spacer for a liquid crystal display (LCD). According to such an example, a mold of cavities can be fabricated with predetermined spacing and/or arrangement of cavities such that spacers fabricated in the cavities will align with desirable locations on the LCD device. Further according to this example, spacers can be fabricated in the cavities as independent spacers and the independent spacers can be harvested from the cavities on a film that aligns in a predetermined manner with the application to be spaced. According to some embodiments, after the film and spacer combination has been placed in its desired location the film can either be dissolved or otherwise removed or can become an integral part of the device. According to another embodiment of this example, excess spacer material can be filled into the cavities such that a desired film interconnects the spacers. Thereafter, the excess spacer material film interconnecting the spacers can provide for desired positioning of the particle spacers. According to another embodiment of this example, a second material can be filled into the cavities such that a resin or film interconnects the spacers.

In some embodiments, the replica pattern of spacers is transferred to other surfaces. In some embodiments, the transfer takes place before the solidification or chemical transformation process of the spacer material. In some embodiments, the transfer takes place after the solidification or chemical transformation process. In some embodiments, the surface to which the spacers are transferred is selected from the group including a non-low surface energy surface, a low surface energy surface, a functionalized surface, a sacrificial surface, spacer layers for devices such as optical devices, display devices, electronic devices, manufacturing processes and devices, automobile manufacturing, or the like. In some embodiments, the methods produce a pattern on a surface that is essentially free of one or more scum layers. In some embodiments, the methods are used to fabricate spacer layers for semiconductors and other electronic and photonic devices or arrays. In some embodiments, the methods are used to create freestanding spacers after dissolving, evaporating, putting into solution, or otherwise removing the layer the spacers are transferred to.

VII. Application of Spacers with a Device

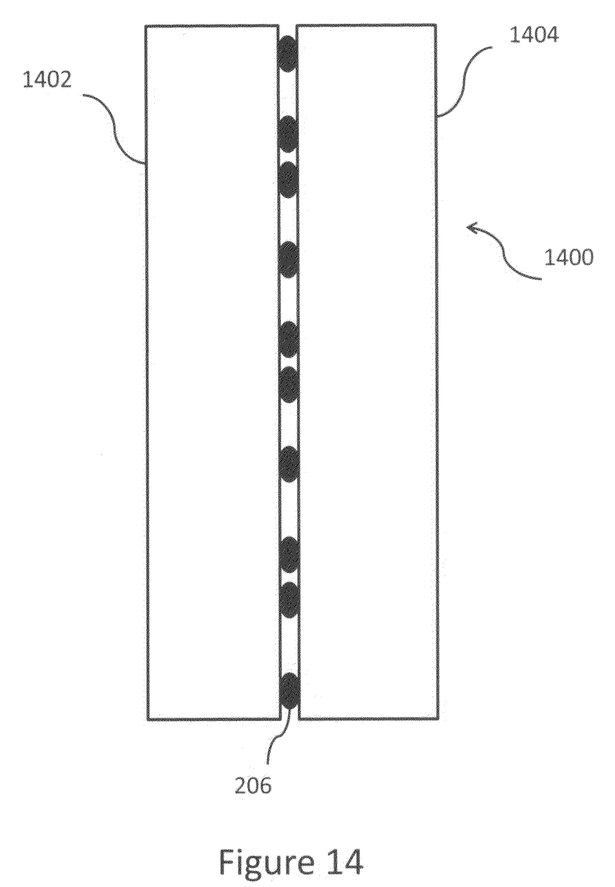

Referring now to FIG. 14, spacers 206 of the present invention can be applied between two components 1402, 1404 of a device 1400. A shape and size of spacers 206 can be designed according to methods and materials of the present invention to space devices 1400 according to particular applications and requirement. According to some embodiments, spacers 206 can be configured with a modulus such that spacers 206 can be positioned adjacent sensitive components 1402, 1404 that require particular modulus. For example, first and/or second component 1402, 1404 can be a glass component of an LCD display and require spacers 206 with chemical and physical characteristics that can interact with glass and not interfere with the optics of the device.

Referring to FIG. 14, spacers 206 can also be positioned in a predetermined relationship to each other or with respect to component 1402, 1404 such as to minimize interference with operation of device 1400 and maximize a gap formation between components 1402, 1404. According to FIG. 14, spacers 206 can have a repetitive and/or alternating distance between individual spacers 206. Such spacer 206 alignment can be achieved, as described herein, by fabricating a mold 108 having cavities 110 arranged in a predetermined ordered or random orientation with adjacent cavities 110.

### EXAMPLES

### Example 1—Fabrication of 110 μm×110 μm×50 μm Spacers

Photolithography was used to generate a 101.6 mm master template out of SU-8 photoresist consisting of an array cubes 110 μm×110 μm×50 μm in size. PET-backed PFPE molds were fabricated from this master by laminating the master to a PET sheet coated with a PFPE tie layer (as described in U.S. patent application Ser. No. 11/633,763, filed on Dec. 4, 2006). The laminator includes two different size rollers. One roller is a 16 mm diameter rubber roller, 228.6 mm length with a Shore A hardness of 30 (measured using ASTM type A durometer) and the other roller is a 30 mm diameter aluminum roller 228.6 mm length. The rollers were closed with 2 pneumatic cylinders (38.1 mm diameter each) thereby pinching the configured sheets at a pressure of 5 psig with 25.4 mm of the layers protruding beyond the exit side of the rollers. Approximately 1 mL of a UV-curable PFPE resin was placed between the PET layer and the master template. The laminator was then actuated at a speed of 0.91 m/minute, laminating the PET sheet to the patterned wafer with a thin film of UV-curable PFPE distributed in between. The roll laminator was then stopped when about 25 mm of the PET/UV-curable PFPE/silicon master remained on the inlet side of the rollers. The rollers were carefully opened to release the PET/UV-curable PFPE/silicon master laminate.

The laminate was exposed to UV light through the PET sheet using a UV flood lamp (ELC-4001 from Electro-Lite Corp, Bethel, Conn.) and was illuminated for 1 minute approximately 76.4 mm from the lamp. After exposure for 2 minutes, the light was extinguished and the laminate was removed. Following removal from the floodlamp, the PFPE layer was carefully separated, by hand peeling at about 25 mm per second from the silicon master. Upon separation, a thin (about 150 micron) PFPE layer was adhered to the PET and the thin PFPE layer included features of the master template.

The PET/PFPE mold was filled with a UV-curable resin, (Trimethylolpropane ethoxylate triacrylate, avg Mn ˜268, containing 1% diethoxyacetophenone by weight) by placing approximately 0.5 mL of resin between the PFPE/PET mold and a fresh PET sheet (untreated side facing liquid). The drop was allowed to spread, covering the entire pattern. The laminate was then placed in a vacuum oven for approximately 5 minutes under a pressure of −30 in Hg until air bubbles were no longer observed.

The laminate was then placed into the laminator described above such that approximately 25 mm of the laminate remained above the roller. The rollers were actuated at a pressure of ˜2 psig. The rollers were then actuated (moving the laminate upward) at a speed of about 0.15 m/min and the sheets were separated at the nip. Upon separation, the mold was found to have precisely filled cavities with clean land areas in between. The resin in the cavities of the filled mold was then cured open faced under a nitrogen purge using a UV flood lamp (ELC-4001 from Electro-Lite Corp, Bethel, Conn.). The chamber was first purged with nitrogen for 1 minute followed by a 2 minute exposure to UV light.

After removal from the curing chamber, the mold filled with cured particles was laminated to a glass plate with approximately 0.1 mL of cyanoacrylate adhesive in between. The rollers were closed with 2 pneumatic cylinders (38.1 mm diameter each) thereby pinching the configured sheets at a pressure of 5 psig with 25 mm of the layers protruding beyond the exit side of the rollers. The laminator was then actuated at a speed of 0.91 m/minute, laminating the filled mold to the glass plate with the adhesive in between. The roll laminator was then stopped when about 25 mm of the PET/PFPE mold laminate glass plate remained on the inlet side of the rollers. The rollers were carefully opened to release the laminate.

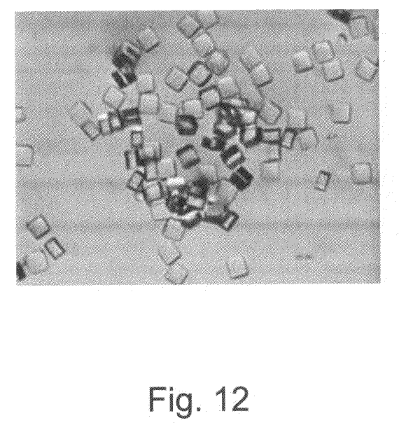

The laminate was separated by peeling the mold back manually revealing harvested particle spacers on a layer of cured cyanoacrylate adhesive. Particle spacers were collected by dissolving the adhesive layer in acetone. The adhesive could be purified from the particle spacers by repeatedly allowing the spacers to settle at the bottom of a vial, pulling off the top solvent layer, and adding fresh solvent. This process was repeated 5 times until the particle spacers were free flowing in the vial. Particle spacers suitable as precisions spacers were removed from the vial and inspected by microscopy and are shown in FIG. 12.

### Example 2—Analysis of 110 μm×110 μm×50 μm Spacers

Particle size distribution data was obtained by measuring the diagonal lengths of a given population of particles in a series of micrographs. A sample was prepared by placing ˜1 mg of purified particles onto a glass microscope slide, placing a second microscope slide on top to sandwich the particles and moving the slides back and forth with the particles in between to orient them in the same plane. Microscope software with a calibrated measure function was then used to measure the longest particle dimension (diagonal length in this case) as shown in FIG. 13. Polydispersity of particle lengths was calculated using equations typically used in calculating polydispersity of polymer chains. In particular, the following equation was used:

Polydipsersity=Mw/Mn=(1+δ²/Mn²)

as described by Sheu, et al. in Journal of Chemical Education Vol 78, No. 4 Apr. 2001, which is incorporated herein by reference, where Mw is the weight average length, Mn is the number average length, and 6 is the standard deviation. A polydispersity of 1.0005 was calculated in this manner for a population of 26, 110 μm×110 μm×50 μm spacers.

What is claimed is:

1. A spacer for forming a gap in a device, comprising:
a first component of a device;
a second component of the device positioned with respect to the first component; and
a spacer positioned between the first component and the second component such that a gap is formed between the first component and the second component, wherein the spacer has a predetermined geometric shape and is less than about 500 micrometers in a broadest dimension.

2. The spacer of claim 1, further comprising a plurality of spacers wherein each spacer of the plurality of spacers has a predetermined geometric shape.

3. The spacer of claim 2, wherein each spacer of the plurality of spacers comprises substantially the same predetermined geometric shape.

4. The spacer of claim 2, wherein each spacer of the plurality of spacers comprises a variety of predetermined geometric shapes.

5. The spacer of claim 2, wherein the plurality of spacers includes polydispersity in broadest dimension of less than about 1.0010.

6. The spacer of claim 2, wherein the plurality of spacers includes polydispersity in broadest dimension of less than about 1.0008.

7. The spacer of claim 2, wherein the plurality of spacers includes polydispersity in broadest dimension of less than about 1.0006.

8. The spacer of claim 2, wherein the plurality of spacers includes polydispersity in broadest dimension of less than about 1.0005.

9. The spacer of claim 1, wherein the spacer is fabricated in a mold comprising the predetermined geometric shape.

10. The spacer of claim 9, wherein the mold comprises a fluoropolymer.

11. The spacer of claim 9, wherein the mold comprises a perfluoropolyether precursor.

12. The spacer of claim 1, wherein the spacer is less than about 400 micrometers in a broadest dimension.

13. The spacer of claim 1, wherein the spacer is less than about 200 micrometers in a broadest dimension.

14. The spacer of claim 1, wherein the spacer is less than about 100 micrometers in a broadest dimension.

15. The spacer of claim 1, wherein the spacer is less than about 50 micrometers in a broadest dimension.

16. The spacer of claim 1, wherein the spacer is less than about 10 micrometers in a broadest dimension.

17. The spacer of claim 1, wherein the spacer is less than about 1 micrometer in a broadest dimension.

18. The spacer of claim 1, wherein the spacer is between about 0.5 micrometers and about 10 micrometers in a broadest dimension.

19. The spacer of claim 1, wherein the spacer is between about 1 micrometer and about 7 micrometers in a broadest dimension.

20. The spacer of claim 1, wherein the spacer is between about 1.5 micrometers and about 5 micrometers in a broadest dimension.

21. The spacer of claim 1, wherein the spacer is between about 2 micrometers and about 4 micrometers in a broadest dimension.

22. The spacer of claim 1, wherein the spacer is less than about 0.75 micrometers in a broadest dimension.

23. The spacer of claim 1, wherein the spacer is less than about 0.5 micrometers in a broadest dimension.

24. The spacer of claim 1, wherein the spacer is less than about 0.25 micrometers in a broadest dimension.

25. The spacer of claim 1, wherein the spacer is less than about 0.10 micrometers in a broadest dimension.

26. The spacer of claim 1, wherein the spacer is less than about 75 nanometers in a broadest dimension.

27. The spacer of claim 1, wherein the spacer is less than about 50 nanometers in a broadest dimension.

28. The spacer of claim 1, wherein the spacer is less than about 25 nanometers in a broadest dimension.

29. The spacer of claim 1, wherein the predetermined geometric shape of the spacer comprises two substantially flat and substantially parallel sides.

30. The spacer of claim 1, wherein the predetermined geometric shape of the spacer includes a predetermined radius of curvature.

31. The spacer of claim 1, wherein the predetermined geometric shape of the spacer includes a predetermined angle between two sides of the spacer.

32. The spacer of claim 1, wherein the spacer is cuboidal shaped.

33. The spacer of claim 1, wherein the spacer is conical shaped.

34. The spacer of claim 1, wherein the spacer is spherical shaped.

35. The spacer of claim 1, wherein the spacer is cylindrical shaped.

36. The spacer of claim 1, wherein the spacer is rectangular shaped.

37. The spacer of claim 1, wherein the spacer is cube shaped.

38. The spacer of claim 1, wherein the spacer is cone shaped.

39. The spacer of claim 1, wherein the spacer is sphere shaped.

40. The spacer of claim 1, wherein the spacer is cylinder shaped.

41. The spacer of claim 1, wherein the spacer is rectangle shaped.

42. The spacer of claim 2, further comprising a film coupled to each spacer of the plurality of spacers.

43. The spacer of claim 42, wherein each spacer of the plurality of spacers is coupled with the film in a predetermined location.

44. The spacer of claim 42, wherein each spacer of the plurality of spacers is coupled with the film in a predetermined random location.

45. The spacer of claim 44, wherein the predetermined random location is mathematically selected.

46. The spacer of claim 45, wherein the mathematically selected predetermined random location reduces a probability of a spacer interfering with a device component.

47. A spacer for forming a gap in a device, comprising:
a film layer; and
a spacer coupled with the film layer wherein the spacer comprises a predetermined geometric shape less than about 500 micrometers in a broadest dimension.

48. The spacer of claim 47, wherein the predetermined geometric shape includes a predetermined radius of curvature.

49. The spacer of claim 47, wherein the predetermined geometric shape includes a substantially flat surface having a predetermined width.

50. The spacer of claim 47, further comprising a plurality of spacers wherein each spacer of the plurality of spacers comprises a predetermined geometric shape.

51. The spacer of claim 50, wherein the predetermined geometric shape of each spacer of the plurality of spacers is substantially equivalent.

52. The spacer of claim 50, wherein the plurality of spacers includes polydispersity in broadest dimension of less than about 1.0010.

53. The spacer of claim 50, wherein the plurality of spacers includes polydispersity in broadest dimension of less than about 1.0008.

54. The spacer of claim 50, wherein the plurality of spacers includes polydispersity in broadest dimension of less than about 1.0006.

55. The spacer of claim 50, wherein the plurality of spacers includes polydispersity in broadest dimension of less than about 1.0005.

56. The spacer of claim 50, wherein the predetermined geometric shape of each spacer of the plurality of spacers includes a predetermined radius of curvature.

57. The spacer of claim 50, wherein the predetermined geometric shape of each spacer of the plurality of spacers includes a substantially flat surface having a predetermined width.

58. The spacer of claim 50, wherein the predetermined geometric shape of each spacer of the plurality of spacers includes two substantially flat surfaces, wherein the two substantially flat surfaces abut with a predetermined angle.

59. The spacer of claim 47, wherein the spacer is integral with the film.

60. The spacer of claim 47, wherein the spacer is positioned in a predetermined location with respect to the film.

61. The spacer of claim 50, wherein each spacer of the plurality of spacers is coupled in a predetermined location on the film.

62. The spacer of claim 47, wherein the film comprises a first composition and the spacer comprises a second composition.

63. The spacer of claim 47, wherein the film and the spacer comprise the same composition.

64. The spacer of claim 47, wherein the film comprises a predetermined thickness.

65. The spacer of claim 47, wherein the spacer is fabricated in a mold.

66. The spacer of claim 65, wherein the mold comprises a fluoropolymer.

67. The spacer of claim 65, wherein the mold comprises a perfluoropolyether precursor.

68. The spacer of claim 47, wherein the spacer is less than about 400 micrometers in a broadest dimension.

69. The spacer of claim 47, wherein the spacer is less than about 200 micrometers in a broadest dimension.

70. The spacer of claim 47, wherein the spacer is less than about 100 micrometers in a broadest dimension.

71. The spacer of claim 47, wherein the spacer is less than about 50 micrometers in a broadest dimension.

72. The spacer of claim 47, wherein the spacer is less than about 10 micrometers in a broadest dimension.

73. The spacer of claim 47, wherein the spacer is less than about 1 micrometer in a broadest dimension.

74. The spacer of claim 47, wherein the spacer is less than about 0.75 micrometers in a broadest dimension.

75. The spacer of claim 47, wherein the spacer is less than about 0.5 micrometers in a broadest dimension.

76. The spacer of claim 47, wherein the spacer is less than about 0.25 micrometers in a broadest dimension.

77. The spacer of claim 47, wherein the spacer is less than about 0.10 micrometers in a broadest dimension.

78. The spacer of claim 47, wherein the spacer is less than about 75 nanometers in a broadest dimension.

79. The spacer of claim 47, wherein the spacer is less than about 50 nanometers in a broadest dimension.

80. The spacer of claim 47, wherein the spacer is less than about 25 nanometers in a broadest dimension.

81. The spacer of claim 47, further comprising:
a first component of a device; and
a second component of the device, wherein the spacer is positioned with respect to the first component to form a controlled gap between the first component and the second component.

82. The spacer of claim 81, wherein the first component and the second component are components of an LCD.

83. The spacer of claim 81, wherein the first component and the second component are components of an automobile.

84. The spacer of claim 81, wherein the first component and the second component are electronic components.

85. The spacer of claim 81, wherein the first component and the second component are optical components.

86. A method for fabricating a micro spacer, comprising:
providing a mold defining a cavity having a predetermined geometric shape, wherein the cavity is less than about 500 micrometers in a broadest dimension;
introducing a spacer precursor material into the cavity;
forming a spacer from the spacer precursor material in the cavity;
removing the spacer from the cavity; and
applying the spacer to a first component of a device such that a gap is formed between the first component of the device and a second component of the device.

87. The method of claim 86, further comprising a plurality of cavities defined in the mold.

88. The method of claim 87, further comprising introducing spacer precursor material into each cavity of the plurality of cavities of the mold and forming spacers in each cavity of the plurality of cavities.

89. The method of claim 86, wherein the mold comprises a fluoropolymer.

90. The spacer of claim 86, wherein the mold comprises a perfluoropolyether precursor.

91. The method of claim 87, wherein the cavities are arranged in predetermined locations with respect to each other.

92. The method of claim 87, wherein the removing the spacers comprises applying a film to the spacers formed in the cavities such that the spacers adhere to the film and removing the film from the mold such that the spacers remain in contact with the film and are removed from the cavities.

93. The method of claim 92, wherein the cavities are arranged in a predetermined location with respect to each other such that the spacers are arranged in a predetermined location with respect to each other on the film after being removed from the cavities.

94. The method of claim 88, wherein the predetermined geometric shape of each spacer of the plurality of spacers is substantially equivalent.

95. The method of claim 88, wherein the predetermined geometric shape of each spacer of the plurality of spacers includes a predetermined radius of curvature.

96. The method of claim 88, wherein the predetermined geometric shape of each spacer of the plurality of spacers includes a substantially flat surface having a predetermined width.

97. The method of claim 88, wherein the predetermined geometric shape of each spacer of the plurality of spacers includes two substantially flat surfaces, wherein the two substantially flat surfaces abut with a predetermined angle.

98. A method for positioning a spacer, comprising:
forming a spacer in a cavity of a mold, wherein the cavity comprises a predetermined geometric shape and is less than about 500 micrometers in a broadest dimension;
harvesting the spacer onto a film; and
positioning the film with respect to a first device that is to be spaced from a second device.

99. The method of claim 98, further comprising a plurality of cavities in the mold and fabricating a spacer in each of the plurality of cavities.

100. The method of claim 99, wherein the cavities are arranged in predetermined locations with respect to each other such that the harvested spacers are arranged in a predetermined orientation with respect to each other.

101. The method of claim 99, wherein the predetermined geometric shape of each spacer of the plurality of spacers is substantially equivalent.

102. The method of claim 99, wherein the predetermined geometric shape of each spacer of the plurality of spacers includes a predetermined radius of curvature.

103. The method of claim 99, wherein the predetermined geometric shape of each spacer of the plurality of spacers includes a substantially flat surface having a predetermined width.

104. The method of claim 99, wherein the predetermined geometric shape of each spacer of the plurality of spacers includes two substantially flat surfaces, wherein the two substantially flat surfaces abut with a predetermined angle.
